(19) United States
(12) Patent Application Publication
(10) Pub. No.: US 2008/0154558 A1
(43) Pub. Date: Jun. 26, 2008

(54) Estimating and controlling states of a fuel cell system

(76) Inventor: Zhi Zhou, Selkirk, NY (US)

Correspondence Address: TROP PRUNER & HU, PC, 1616 S. VOSS ROAD, SUITE 750, HOUSTON, TX, 77057-2631, US

(21) Appl. No.: 11/644,710

(22) Filed: Dec. 22, 2006

(51) Int. Cl. G06F 17/10

(52) U.S. Cl. 703/2

(57) ABSTRACT

A fuel cell system includes at least one sensor and a controller. The sensor(s) provide data that is indicative of at least one directly measurable state of the fuel cell system. The controller is coupled to the sensor(s) to provide a mathematical model that is indicative of system dynamics of a state space of the fuel cell system for at least one state that is not directly measurable and the state(s) that are directly measurable. The controller generates estimate(s) of the state(s) that are not directly measurable based on the data and the model.

### BACKGROUND

The invention generally relates to estimating and controlling states of a fuel cell system.

A fuel cell is an electrochemical device that converts chemical energy directly into electrical energy. There are many different types of fuel cells, such as solid oxide, molten carbonate, phosphoric acid, methanol and proton exchange membrane (PEM) fuel cells.

As a more specific example, a PEM fuel cell includes a PEM membrane, which permits only protons to pass between an anode and a cathode of the fuel cell. A typical PEM fuel cell may employ polysulfonic-acid-based ionomers and operate up to 80° Celsius. (C.). Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, a technique includes providing a mathematical model that is indicative of system dynamics in a state space of a fuel cell system for at least one state that is not directly measurable and at least one state that is directly measurable. The technique includes receiving feedback from the fuel cell system and estimating the state(s) that are not directly measurable based on the feedback and the model.

In another embodiment of the invention, a fuel cell system includes at least one sensor and a controller. The sensor(s) provide data that is indicative of at least one directly measurable state of the fuel cell system. The controller is coupled to the sensor(s) to provide a mathematical model that is indicative of system dynamics in a state space of the fuel cell system for at least one state that is not directly measurable and the state(s) that are directly measurable. The controller generates estimate(s) of the state(s) that are not directly measurable based on the data and the model.

In yet another embodiment of the invention, a fuel cell system includes at least one sensor and a controller. The sensor(s) provide data that is indicative of at least one directly measurable state of the fuel cell system. The controller is coupled to the sensor(s) to provide a mathematical model that is indicative of system dynamics in a state space of the fuel cell system for at least one state that is not directly measurable and the state(s) that are directly measurable.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to estimate states of the fuel cell system according to an embodiment of the invention.

FIG. 3 is an illustration of a state space model of the fuel cell system according to an embodiment of the invention.

FIG. 4 illustrates application of the model of FIG. 3 to generate state estimates and to control both the measured and estimated state(s) for the fuel cell system according to an embodiment of the invention.

### DETAILED DESCRIPTION

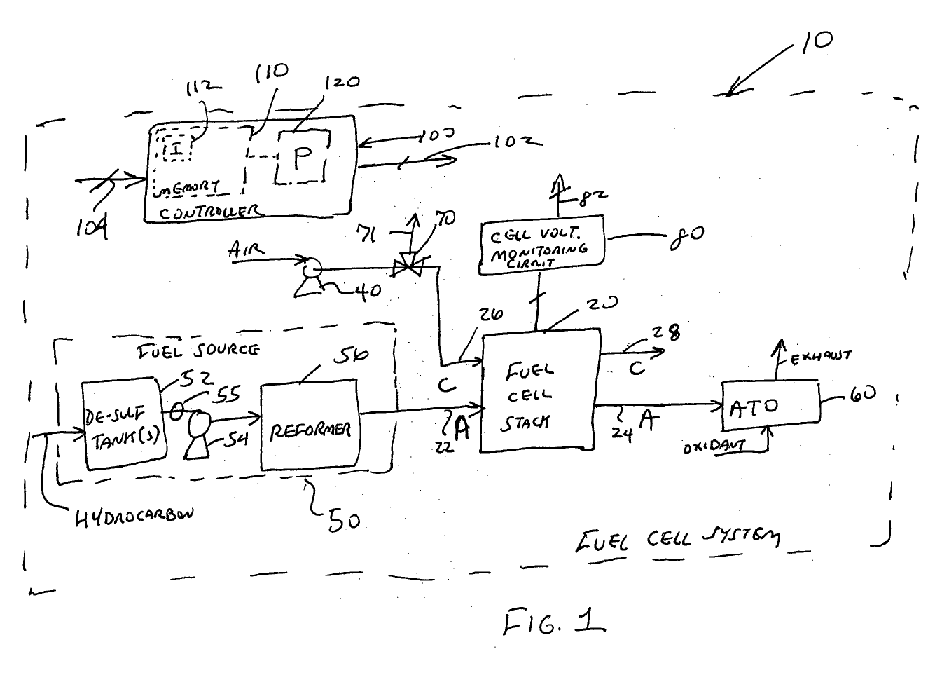

Referring to FIG. 1, an embodiment 10 of a fuel cell system in accordance with the invention includes a fuel cell stack 20, which produces electrical power for an external load (not shown) of the system 10. In this regard, reactant flows, such as oxidant and fuel flows, are communicated through the cathode and anode chambers, respectively, of the fuel cell stack 20 for purposes of promoting electrochemical reactions that generate the electrical power.

In general, an anode inlet 22 of the fuel cell stack 20 receives the fuel flow from a fuel source 50, which may be a reformer, hydrogen tank, etc., depending on the particular embodiment of the invention. The fuel flow through the anode chamber of the fuel cell stack 20 produces an anode exhaust flow, which appears at an anode outlet 24 of the stack 20. Depending on the particular embodiment of the invention, the anode exhaust may be provided to an anode tailgas oxidizer (ATO) 60 which oxidizes fuel that is not consumed by the stack's electrochemical reactions and thus, is present in the anode exhaust. It is noted that the fuel cell system 10 is merely an exemplary embodiment, in that other variations are contemplated and are within the scope of the appended claims. For example, in accordance with other embodiments of the invention, the anode chamber of the fuel cell stack may not have an outlet (except perhaps a purge outlet) and thus, may be “dead-headed.”

The incoming oxidant flow to the fuel cell stack 20 may be received at a cathode inlet 26 of the stack 20. The flow through the cathode chamber of the fuel cell stack 20 produces a cathode exhaust, which appears at a cathode outlet 28. The oxidant flow to the fuel cell stack 20 may be provided by an air blower 40, for example. The air blower 40 produces an air flow, or oxidant flow, which during operation of the fuel cell system 10 passes through a three-way valve 70 to the cathode inlet 26. In general, the fuel cell system 10 may control operation of the three-way valve 70 for purposes of dividing the air flow from the air blower 40 between the cathode inlet 26 and an oxidant inlet of the ATO 60, as further described in U.S. patent application Ser. No. ______, entitled, “CONTROLLING OXIDANT FLOWS IN A FUEL CELL SYSTEM,” which is filed concurrently herewith, has a common assignee with the present application and is incorporated by reference in its entirety.

The fuel cell system 10 has various states, some of which are directly measurable and some of which are not. As an example of a directly measurable state, a cell voltage monitoring circuit 80 may scan the cell voltages of the fuel cell stack 20 for purposes of providing indications (at its output terminals 82) of the various cell voltages of the stack 20 to control circuitry (described below). Thus, for this example, each measured cell voltage is representative of a state that may be directly measured. As another example of a directly measured state, the fuel source 50 may be formed from a reformer 56 that receives a hydrocarbon flow and produces a corresponding reformate flow that serves as the fuel flow to the fuel cell stack 20. The hydrocarbon flow that is received by the reformer 56 is a mixture of a hydrocarbon and air, which is furnished by a blower 54. The blower 54, in turn, receives a hydrocarbon flow from one or more desulfurization tanks 52 of the fuel source 50. In this regard, the desulfurization tanks 52 may remove various sulfur compounds, such as mercaptens, from an incoming hydrocarbon flow (a liquefied petroleum gas (LPG) or natural gas flow, as examples) to the fuel cell system 10. The fuel source 50 may include a flow meter 55 that is connected to the outlet of the tank(s) 52 for purposes of directly measuring the fuel flow from the desulfurization tank(s) 52. Thus, from the signal that is provided by the flow meter 55, the fuel cell system 10 may be able to determine the incoming fuel flow to the reformer 50. Other examples of directly measured states are reactor states (such as reformer and/or ATO states) and outlet temperatures (not shown in FIG. 1), which are readily and economically attainable.

Several states of the fuel cell system 10 may not be directly measurable, due to the associated costs or other impracticality of incorporating a sensor into the fuel cell system 10 for purposes of measuring the state. For example, it may be relatively costly to install a sensor at the outlet of the reformer 56 for purposes of measuring the hydrogen production by the reformer 56. As another example, the level of carbon monoxide in the fuel cell system 10 may be an important state to monitor, as carbon monoxide may damage membranes of the fuel cell stack 20, should the carbon monoxide exceed a certain threshold. However, a dedicated carbon monoxide sensor may be relatively costly or impractical for the fuel cell system 10. As another example, it may be desirable to measure the hydrogen content in the anode exhaust from the fuel cell stack 20, although a sensor to perform such a measurement may be relatively costly or otherwise impractical. More examples of states that may not be directly measurable due to technological and/or economical reasons are oxygen-to-carbon ratio and a steam-to-carbon ratio of flows that are fed into the reformer; and the relative humidity (RH) of oxidant and reactant flows into the fuel cell stack 20.

Thus, in general, the states that are estimated (and not directly measured) using the techniques disclosed herein may include one or more of the following (as a non-exhaustive list): an oxygen-to-carbon ratio of a flow into a reformer for hydrogen production, a steam-to-carbon ratio of a flow into the reformer for hydrogen production, a hydrogen production of the reformer, a composition of reformate produced by the reformer, a carbon monoxide level in a reformate fuel in a fuel cell system component (such as a fuel cell stack or reactor, as examples), a relative humidity of a fuel flow into a fuel cell stack, a relative humidity of an oxidant flow into a fuel cell stack, a hydrogen concentration of a flow that enters the fuel cell system component, and a hydrogen concentration of a flow that exits the fuel cell system component.

Instead of providing a sensor to measure every state of the fuel cell system 10, which may be important for the fuel cell system's control, the system 10 instead estimates the states that are not directly measured using feedback from the fuel cell system 10 and a state space model, which characterizes the system dynamics with states of the fuel cell system 10, including directly measurable states and states that are not directly measurable. Therefore, the number of required sensors in the fuel cell system 10 may be kept to a minimum number, which reduces the overall system cost and reliability.

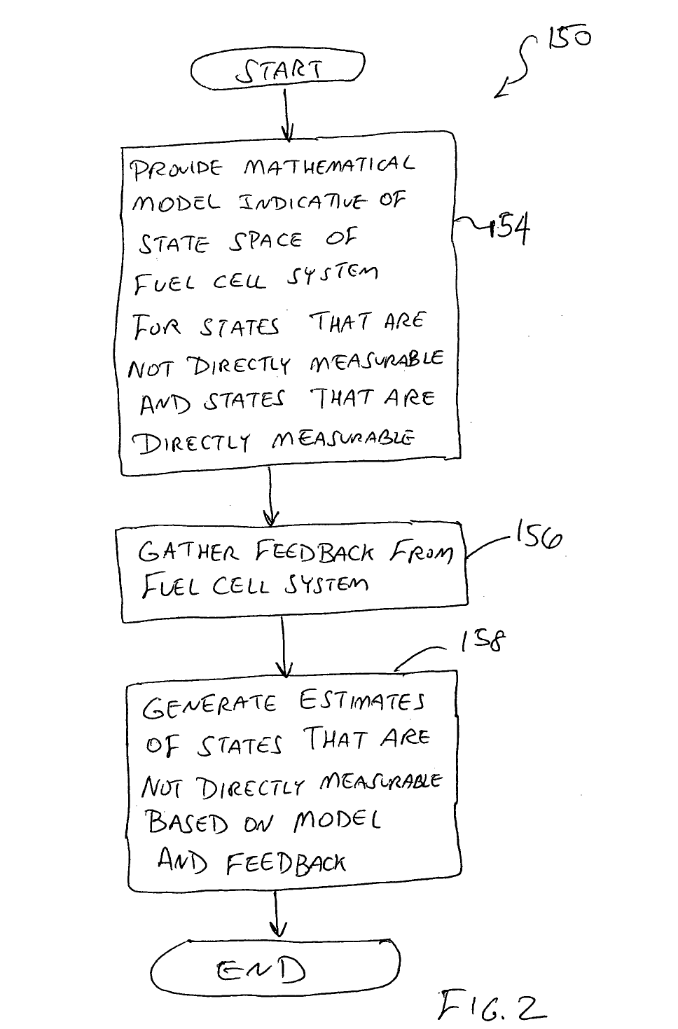

Referring also to FIG. 2, as set forth herein, the fuel cell system 10 performs a technique 150 to estimate non-directly measured states. Pursuant to the technique 150, the fuel cell system 10 provides (block 150) a mathematical model that is indicative of system dynamics in state space of the fuel cell system with states that are not directly measurable and states that are directly measurable. Feedback is gathered (block 156) from the fuel cell system; and estimates of states that are not directly measurable are generated (block 158) based on the model and feedback.

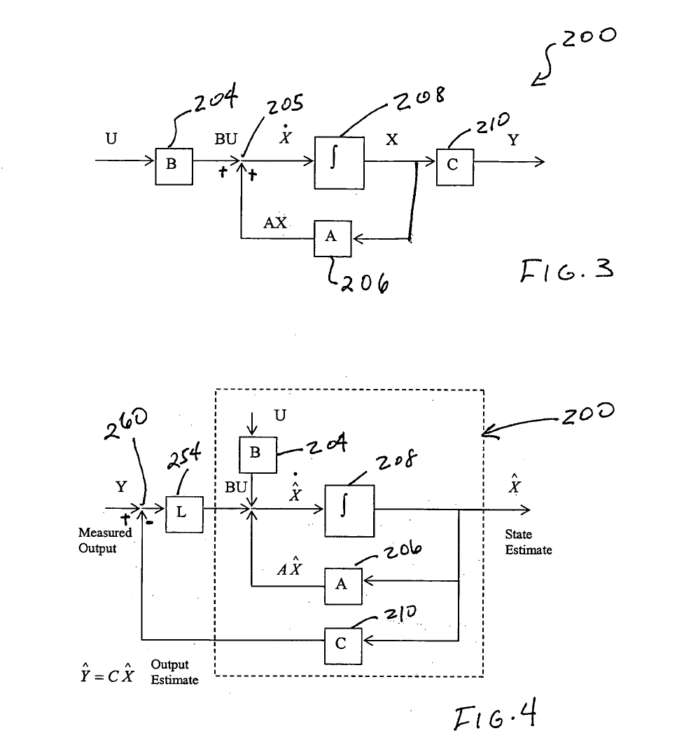

As a more specific example, FIG. 3 depicts a state space model 200 of the fuel cell system 10, in accordance with some embodiments of the invention, and may be represented by the following equations. The model 200 reflects a first order linearized state space model of the fuel cell system 10, which is set forth below in Equations 3 and 4:

\dot{X}=AX+BU and Eq. 3

Y=CX. Eq. 4

In Equations 3 and 4 above, “A,” which is represented by block 206 in FIG. 3, is an n×n coefficient matrix for an n×1 state vector called “X.” The X state vector contains both states that are not directly measurable and states that are directly measurable. “B,” which is represented by block 204 in FIG. 3, is an n×m coefficient matrix for an m×1 control vector called “U,” which has m control inputs. The notation “\dot{X}” represents the time derivative of the X state vector. Thus, in FIG. 3, an integral block 208 transforms the \dot{X} vector into the X state vector. In Equation 4, “Y” is an output vector of p elements and represents outputs of the fuel cell system 10 that may be directly measurable. “C” is a p×n coefficient matrix that converts states into outputs.

All of the states that are set forth in the X state vector are observable, which means all of the states may either be measured directly or estimated, if the following observability matrix is non-singular or full rank:

$$O = {[ \begin{matrix}C \\ CA \\ ⋮ \\ {CA}^{n - 1}\end{matrix} ]}_{n \times n} . \qquad Eq . 5$$

As a more specific example, assume the following:

$$\begin{matrix}A = [ \begin{matrix}- 0.3 & 0 & 0 \\ 0.2 & - 0.2 & 0 \\ 0 & 0.1 & - 0.1\end{matrix} ] , & Eq . 6 \\ C = [ \begin{matrix}0 & 0 & 1\end{matrix} ] , & Eq . 7 \\ X = [ \begin{matrix}{x}_{1} \\ {x}_{2} \\ {x}_{3}\end{matrix} ] , & Eq . 8 \\ Y = CX = {x}_{3} . & Eq . 9\end{matrix}$$

If state x₃ is measured, then the states x₁ and x₂ are observable due to the following relationship:

$$O = {[ \begin{matrix}C \\ CA \\ ⋮ \\ {CA}^{n - 1}\end{matrix} ]}_{n \times n} = [ \begin{matrix}0 & 0 & 1 \\ 0 & 0.1 & - 0.1 \\ 0.02 & - 0.03 & 0.01\end{matrix} ] . \qquad Eq . 10$$

Therefore, in the example above, the matrix O has full rank of three, because |O| is equal to 0.002, which is not zero. As examples, the observed states x₁ and x₂ may be gas compositions, carbon monoxide, hydrogen flows, oxygen-to-carbon ratio, or steam-to-carbon ratio in the fuel cell system. The measured states may be hydrogen carbon fuel flow or reactor temperatures, as examples.

Given the example set forth above, state estimates for the fuel cell system may be derived using the model and feedback from the fuel cell system 10, as set forth below:

$$\dot{\hat{X}} = A \hat{X} + BU + L ( Y - C \hat{X} ) , \qquad Eq . 11$$

Equation 11 is graphically depicted in FIG. 4. As can be seen at reference numeral 260 of FIG. 4, the measured output Y is mathematically combined with the estimated output provided by the model 200. The difference between the measured and estimated outputs are then scaled by an observer gain matrix L (see block 254) and provided as an input to the model 200 to generate the state estimate. The matrix L can be determined with a number of techniques such as pole placement or Kalman filtering. More specifically as an example, solving the eigen value problem, λ|A−LC|=−0.5, −1, −1.5, derived from Eq. 10, would make the observer dynamics 5 times faster than the original process defined by Eq. 3. The resulted observer gain matrix is L=[8.4 14.4 2.4]^{T}.

Referring back to FIG. 1, among the other features of the fuel cell system 10, in accordance with some embodiments of the invention, the fuel cell system 10 may include a controller 100, which may represent an integrated semiconductor package, microprocessor board, computer platform, etc., depending on the particular embodiment of the invention. Regardless of its form, the controller 100 includes a memory 110 which stores program instructions 112 that when executed by the controller 100 cause the controller 100 to provide the state model, as well as estimate and control the states for the fuel cell system 10, as set forth herein. In this regard, the controller 100 may include a processor 120 that executes the instructions 112. The processor 120 may be formed from one or more microcontrollers and/or microprocessors, depending on the particular embodiment of the invention. In general, the controller 100 includes various input terminals 104, which may be used to communicate various sensor measurements, communications from other controllers, measured voltages, currents, etc. to the controller 100. The controller 100 may also include output terminals 102, which are used to generate control signals for purposes of controlling the various components of the fuel cell system 10, as well as signals related to communicating messages, etc. to and from the fuel cell system 10.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method, comprising:
providing a mathematical model indicative of system dynamics in a state space of a fuel cell system for at least one state that is not directly measurable and at least one state that is directly measurable;
receiving feedback from the fuel cell system; and
estimating said at least one state that is not directly measurable based on the feedback and the model.

2. The method of claim 1, wherein the act of receiving feedback comprises:
measuring at least one signal indicative of said at least one directly measurable state.

3. The method of claim 1, wherein all of the states are either directly measurable or observable.

4. The method of claim 1, wherein said at least one state that is not directly measurable comprises at least one of the following: an oxygen-to-carbon ratio of a flow into a reformer for hydrogen production, a steam-to-carbon ratio of a flow into the reformer for hydrogen production, a hydrogen production of the reformer, a composition of reformate produced by the reformer, a carbon monoxide level in a reformate fuel in a fuel cell system component, a relative humidity of a fuel flow into a fuel cell stack, a relative humidity of an oxidant flow into a fuel cell stack, a hydrogen concentration of a flow that enters the fuel cell system component, and a hydrogen concentration of a flow that exits the fuel cell system component.

5. The method of claim 1, wherein the act of providing model comprises modeling system dynamics in state space as a first order linear or linearized state space model.

6. A fuel cell system comprising:
at least one sensor to provide data indicative of at least one directly measurable state of the fuel cell system; and
a controller coupled to said at least one sensor to:
providing a mathematical model indicative of system dynamics in a state space of the fuel cell system for at least one state that is not directly measurable and said at least one state that is directly measurable; and
generate an estimate of said at least one state that is not directly measurable based on the data and the model.

7. The fuel cell system of claim 6, wherein the controller is adapted to:
measure said at least one directly measurable state; and
generate the estimate based on, at least in part, the measurement.

8. The fuel cell system of claim 6, wherein all of the states are either directly measurable or observable.

9. The fuel cell system of claim 6, wherein said at least one state that is not directly measurable comprises at least one of the following: an oxygen-to-carbon ratio of a flow into a reformer for hydrogen production, a steam-to-carbon ratio of a flow into the reformer for hydrogen production, a hydrogen production of the reformer, a composition of reformate produced by the reformer, a carbon monoxide level in a reformate fuel in a fuel cell system component, a relative humidity of a fuel flow into a fuel cell stack, a relative humidity of an oxidant flow into a fuel cell stack, a hydrogen concentration of a flow that enters the fuel cell system component, and a hydrogen concentration of a flow that exits the fuel cell system component.

10. The fuel cell system of claim 6, wherein the model comprises a first order linear differential model.

11. The fuel cell system of claim 6, wherein the controller controls said at least one state that is directly measurable and controls said at least one state that is not directly measurable.

12. An article comprising a computer accessible storage medium storing instructions that when executed by a processor-based system cause the processor-based system to:
provide a mathematical model indicative of system dynamics of a state space of a fuel cell system for at least one state that is not directly measurable and at least one state that is directly measurable;
receive feedback from the fuel cell system; and
estimate said at least one state that is not directly measurable based on the feedback and the model.

13. The article of claim 12, the storage medium storing instructions that when executed by the processor-based system cause the processor-based system to:
measure at least one signal indicative of said at least one directly measurable state and estimates that at least one state that is not directly measurable based at least in part on the measurement.

14. The article of claim 12, wherein all of the states are either directly measurable or observable.

15. The article of claim 12, wherein said at least one state that is not directly measurable comprises at least one of the following: an oxygen-to-carbon ratio of a flow into a reformer for hydrogen production, a steam-to-carbon ratio of a flow into the reformer for hydrogen production, a hydrogen production of the reformer, a composition of reformate produced by the reformer, a carbon monoxide level in a reformate fuel in a fuel cell system component, a relative humidity of a fuel flow into a fuel cell stack, a relative humidity of an oxidant flow into a fuel cell stack, a hydrogen concentration of a flow that enters the fuel cell system component, and a hydrogen concentration of a flow that exits the fuel cell system component.

16. The article of claim 12, wherein the model comprises a first order linear differential model.
